(19) United States
(12) Patent Application Publication
(10) Pub. No.: US 2009/0037537 A1
(43) Pub. Date: Feb. 5, 2009

(54) Tracking Electronic Mail History

(75) Inventors: Sean Callanan, Dublin (IE); Al Chakra, Apex, NC (US); Sonya Purcell, Tipperary (IE); Hugh P. Smyth, Dublin (IE)

Correspondence Address: MARCIA L. DOUBET LAW FIRM, PO BOX 422859, KISSIMMEE, FL, 34742, US

(73) Assignee: INTERNATIONAL BUSINESS MACHINES CORPORATION, Armonk, NY (US)

(21) Appl. No.: 11/832,275

(22) Filed: Aug. 1, 2007

(51) Int. Cl. G06F 15/16

(52) U.S. Cl. 709/206

(57) ABSTRACT

Tracking history of e-mail messages. A tracking request can be sent at any time, and need not be specified prior to or during the sending of the e-mail message. In one embodiment, tracking is requested by resending an earlier-sent message to the recipient, and associated with this resent message is a tracking request X-header. A recipient of the tracking request X-header responds by returning a reply X-header in a reply message along with tracking information pertaining to the original e-mail message. One alternative embodiment embeds an e-mail object in an e-mail message to request the tracking instead of using a request X-header, and similarly, uses an e-mail object to provide the reply instead of using a reply X-header. Users may be allowed to specify whether their e-mail client will respond to tracking requests and/or may be allowed to specify criteria for automating this decision.

### BACKGROUND OF THE INVENTION

The present invention relates to computers, and deals more particularly with tracking history of e-mail messages.

Electronic mail, more commonly referred to as “e-mail”, has become pervasive as a means of communications. As is well known, e-mail systems accept electronic messages and store them for delivery; the delivery occurs when the recipient logs on to the e-mail system and receives his or her waiting messages. A sender of an e-mail message is generally unaware of when the recipient receives a particular sent message, unless the recipient takes action to notify the sender (for example, by sending a return e-mail message acknowledging the original message in some way) or unless the e-mail message is sent with a “return receipt” feature enabled. In this latter case, an acknowledgement message may be sent to the sender automatically when the recipient opens the e-mail message (although some return receipt features may allow the recipient to suppress sending of this automatic acknowledgement).

### BRIEF SUMMARY OF THE INVENTION

The present invention is directed to tracking history of electronic mail (“e-mail”) messages. In one embodiment, this comprises: sending, from a first e-mail client to a second e-mail client, a tracking request to request history pertaining to an e-mail message previously sent from the first e-mail client to the second e-mail client, the tracking request identifying the previously-sent e-mail message and configured to cause the second e-mail client to return the requested history to the first e-mail client. The tracking request may comprise a copy of the previously-sent e-mail message with a tracking request X-header appended thereto; in another approach, the tracking request comprises a copy of the previously-sent e-mail message with a tracking request e-mail object embedded therein. The history may be gathered, for example, from local storage accessible to the second e-mail client or from storage accessible to an e-mail server upon request from the second e-mail client, and may comprise (by way of example) how the previously-sent e-mail message was processed at the first e-mail client.

In another embodiment, the present invention comprises: receiving, at a second e-mail client from a first e-mail client, a tracking request that requests history pertaining to an e-mail message previously sent from the first e-mail client to the second e-mail client, the tracking history tracking request identifying the previously-sent e-mail message; gathering the requested history, by the second e-mail client; and returning the requested history as a reply sent from the second e-mail client to the first e-mail client. The reply may comprise a copy of the previously-sent e-mail message with a tracking reply X-header appended thereto; as one alternative, the reply comprises a copy of the previously-sent e-mail message with a tracking reply e-mail object embedded therein.

In another embodiment, the present invention comprises: forwarding a tracking request from a first e-mail client to a second e-mail client, the tracking request to request history pertaining to an e-mail message previously sent from the first e-mail client to the second e-mail client, the tracking request identifying the previously-sent e-mail message and configured to cause the second e-mail client to return the requested history to the first e-mail client; and forwarding a reply from the second e-mail client to the first e-mail client, responsive to the second e-mail client receiving the tracking request from the first e-mail client and returning the gathered history in the reply, the reply configured to cause the first e-mail client to process the gathered history.

Embodiments of these and other aspects of the present invention may also, or alternatively, be provided as systems or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIGS. 1 and 2 provides flowcharts illustrating logic which may be used when implementing an embodiment of the present invention;

FIG. 3 depicts components used in one embodiment of the present invention;

FIG. 4 depicts a data processing system suitable for storing and/or executing program code; and

FIG. 5 depicts a representative networking environment in which one or more embodiments of the present invention may be used.

### DETAILED DESCRIPTION OF THE INVENTION

Although e-mail messaging provides a tremendous amount of flexibility and convenience for people to communicate with each other, problems may arise in some circumstances. Suppose, for example, that an e-mail user “Bill” is a support engineer for a software company, and that Bill's responsibilities include handling second-level problem reports. That is, Bill's role includes investigating reports on problems that cannot be immediately solved by lower-level support personnel and which must be referred to more experienced personnel such as Bill.

It may be common that Bill does some initial investigation and thereby discovers that he needs to contact a software developer for more information or assistance, and Bill may send an e-mail message for this purpose. Such e-mail messages generally have no formal structure, and instead may be composed as a free-form message to the software developer. After sending the e-mail message, Bill typically relies on the software developer to respond with the requested information or assistance.

It may also be common that the software developer does not respond to Bill in a timely manner. The developer may be busy with other tasks, for example, or may choose not to give priority to Bill's request; or, Bill's request may be overlooked for other reasons. Failure to receive a response from the developer may prevent Bill from being able to complete his problem resolution task, and Bill may have to resort to other approaches such as escalating to a manager in the software development organization or finding an alternative software developer and beginning the process anew. Such approaches represent an inefficient use of resources and introduce unnecessary delay into the business process.

In the general case, Bill does not know why his e-mail message to the software developer went unanswered. It could be, for example, that the developer didn't read (or perhaps even receive) the message, or it may have been automatically transferred to a junk e-mail folder during an automated filtering operation, or it may have been accidentally deleted by the developer before it was read, and so forth. Without some type of information about what happened to his original e-mail message, Bill cannot make an informed decision about how best to proceed in the absence of a response. For example, if Bill assumes that the developer intentionally ignored the message when in fact the message was lost in transmission and didn't reach the developer, Bill might become frustrated and make remarks when escalating to management that could damage Bill's future working relationship with the software developer.

By contrast, if Bill had information about whether his message was received and/or opened by the software developer, he could react to a lack of response in a more appropriate manner. For example, if Bill knew that the message was identified as junk e-mail by an automated filter, he might decide to call the software developer instead of attempting further e-mail communications. Or, if he knew that the message arrived but was not opened by the recipient, Bill might decide to resend the message with an “urgent” flag set to thereby call the message to the developer's attention. As another possibility, it might happen that the developer received the message and forwarded it to a colleague with specialized knowledge, and that this colleague is working on Bill's request. If he had this information, Bill might send a reminder message to the colleague or perhaps contact the colleague by phone.

Current art allows an e-mail sender to request various types of information about an e-mail message before sending the message. For example, the sender might request a delivery confirmation, return receipt, and/or route tracing for the message. However, the present inventors know of no current systems that provide detail regarding what happened to the message after it was received at the recipient's system. And, a major drawback of such current systems is that the e-mail message sender must know in advance of sending the message that he wants to use the delivery confirmation, return receipt, and/or route tracing for the message and must take appropriate action before the message is sent.

While the e-mail communications problems described above are illustrated in terms of a particular business scenario, it will be obvious to the reader that these problems are representative of many other e-mail communication scenarios and that such scenarios are not limited to a business environment: similar problems may occur in e-mail communications among friends and family members as well as among business colleagues.

By contrast to the current art, embodiments of the present invention enable an e-mail message sender to initiate history tracking operations (which may also referred to herein as “tracking”) on a particular message after the message has already been sent; this may be referred to as “post-transmission tracking”. The tracking may even be initiated after the message has been received at the recipient's e-mail system; this may be referred to as “post-delivery tracking”.

History tracking details provided by an embodiment of the present invention may comprise how a particular message was managed in the recipient's e-mail system, including whether the receiving user explicitly deleted the message; whether it was automatically transferred to a junk e-mail folder by an automated filter; whether the user opened the message but did not create a response; whether the user created a response but did not yet send it; and so forth. Other types of tracking information that may be provided by an embodiment of the present invention include, by way of illustration but not of limitation, whether the message is read or unread; whether the message has been filed in a folder or forwarded to another user; whether the message has been marked as junk e-mail; and whether the user has explicitly performed actions on the message and/or whether automated actions have been performed on the message. Notably, the history tracking information for a particular e-mail message may persist for a longer period of time than that particular e-mail message itself (e.g., in cases where the history indicates that the e-mail message was deleted).

Optionally, an embodiment of the present invention may enable an e-mail recipient to control the level of reporting that his e-mail system will provide to a message sender's e-mail system. In addition or instead, an embodiment of the present invention may optionally enable an e-mail recipient to be notified that a request for tracking information is received. In either case, one manner in which such control features may be enabled or disabled is through use of configuration data. Configuration data is discussed in more detail below.

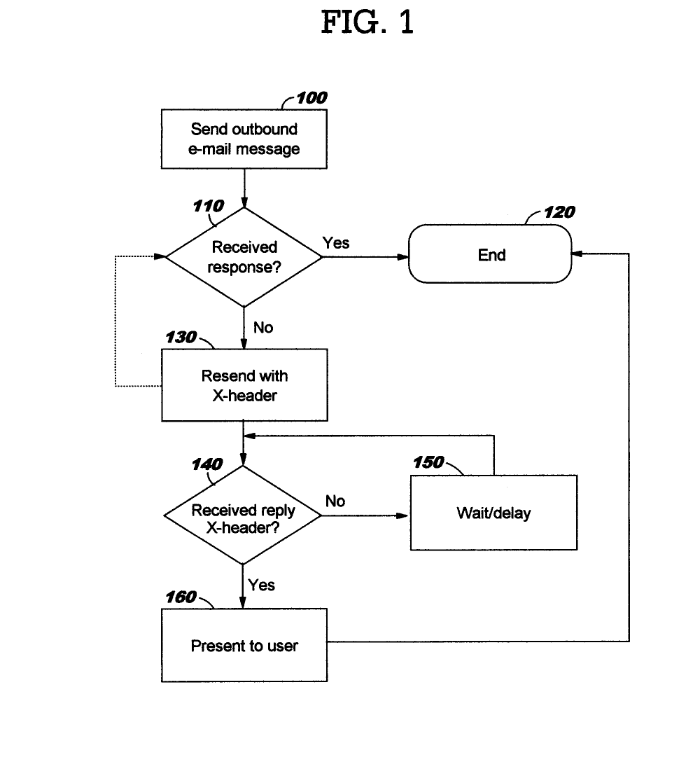

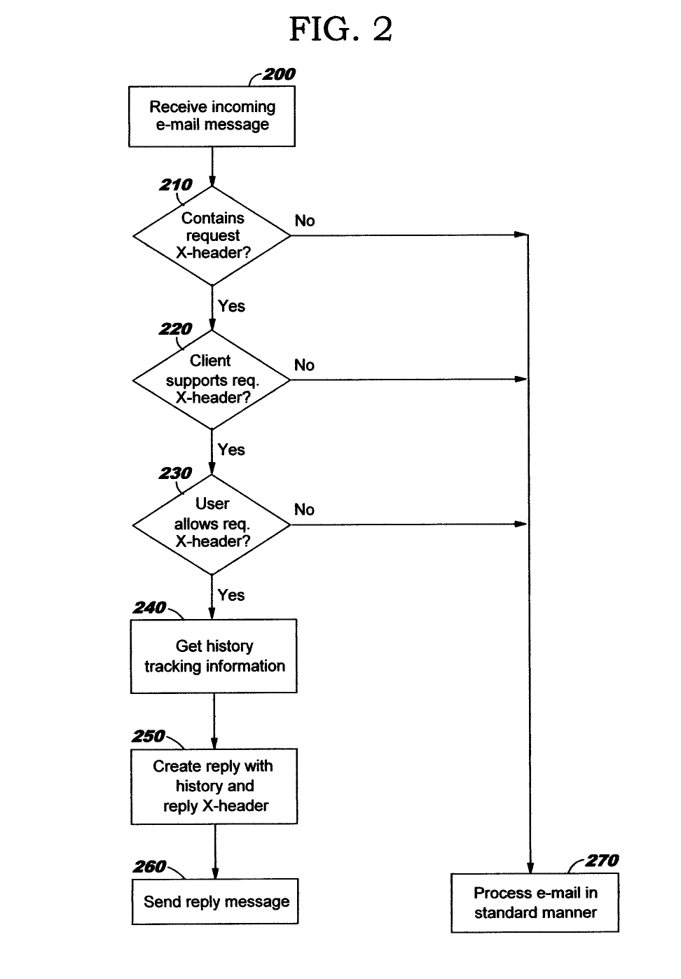

Referring now to FIGS. 1 and 2, flowcharts are provided to illustrate logic which may be used when implementing an embodiment of the present invention. FIG. 1 provides a sender-side perspective, and FIG. 2 provides a receiver-side perspective, as will now be described in more detail.

As shown in FIG. 1, an e-mail message sender sends an outbound mail message from an e-mail system (Block 100), where this e-mail system is also referred to herein as an e-mail client. (Messages discussed herein may be forwarded between e-mail clients through an e-mail server. A configuration of this type is well known to those of skill in the art, and a detailed discussion thereof is not deemed necessary to an understanding of the present invention). This outbound message may be addressed to one or more recipients. For ease of reference, discussions herein focus on a single recipient. It will be obvious, based on the teachings herein, how these discussions may be adapted in terms of multiple recipients.

Block 110 tests whether the sending user receives a response as expected. For example, if the original e-mail message includes a question for the recipient, then Block 110 corresponds to determining whether an answer to that question has been received. Preferably, a user provides the answer to the test at Block 110. For example, a dialog window or other technique may be used for querying the sending user as to whether the expected response is received. As one alternative, a programmatic process may be provided for making this determination. If the test in Block 110 has a positive result, then no further actions are deemed necessary for this e-mail message and the processing of FIG. 1 may exit as in a prior art e-mail processing approach (Block 120).

Otherwise, when the test in Block 110 has a negative result, the sender uses techniques disclosed herein that resend the original e-mail message with a history tracking request associated therewith (Block 130). In one approach, associating a history tracking request with an e-mail message comprises appending a new request X-header to the e-mail message that connotes a history tracking request, and this request X-header triggers the receiving e-mail system to handle the request for tracking history. Resending the original e-mail request with this new request X-header enables a recipient e-mail system to determine which e-mail message is the subject of the history tracking request. (The general concepts of X-headers and their use in e-mail messages is well known to those of skill in the art, however use of X-headers for tracking history of e-mail messages, as disclosed herein, is not). The receiver-side response to receiving the request X-header is discussed in more detail below with reference to FIG. 2.

As one alternative approach to the logic illustrated in FIG. 1, an embodiment of the present invention may be adapted for allowing the e-mail message sender to request history tracking without regard to the test represented by Block 110. In this case, the test in Block 110 may be omitted and may be replaced (for example) by querying the e-mail message sender to determine whether he or she desires to send a history tracking request.

After resending the e-mail message with its associated history tracking request, control may optionally transfer from Block 130 to Block 110 (as shown by a dotted line in FIG. 1) to again test whether the sender receives the expected response to the original e-mail message. A counter may be used, if desired, to place an upper limit on the number of times this iterative processing occurs. Or, as another alternative, the iteration may be omitted.

Referring now to FIG. 2, the receiver-side e-mail system receives an incoming e-mail message (Block 200). Block 210 tests to see whether this incoming message includes a request X-header for history tracking. If this test has a negative result, processing continues at Block 270 where the e-mail message is preferably processed using prior art techniques.

When the test in Block 210 has a positive result, on the other hand, then processing continues at Block 220. Block 220 tests whether this e-mail client supports the requested tracking. This test may have a negative result, for example, for a prior art e-mail system. If the client does not support the request X-header, processing continues at Block 270.

FIG. 2 indicates the processing at Block 270, by way of illustration but not of limitation, as processing the e-mail message using prior art techniques. A number of alternative approaches (not shown in FIG. 2) may be used without deviating from the scope of the present invention. As one alternative, the e-mail message and its associated request X-header may be discarded. As another alternative, a message or other notification may be provided at the receiver-side client e.g., by recording information in a log file or displaying a message on a user interface device to notify the user of the tracking request. As yet another alternative, the e-mail message may be presented to the receiving user simply as an inbound e-mail message or as a resent message for which tracking will not be provided. Block 270 may further comprise enabling the user to take whatever manual action he or she deems appropriate for this e-mail message.

When control reaches Block 230, this is an indication that the receiver-side e-mail client supports processing for the history tracking request X-header described herein. Block 230 then tests whether the user of this e-mail client allows such requests to be processed. As mentioned earlier, configuration data may be used for recording the user's preferences, and such configuration data may be processed to answer the test at Block 230 in a manner transparent to the user. The configuration data may comprise, by way of example, specifying that this particular user either approves (or disapproves) of all history tracking requests, or that this user approves (or disapproves) of history tracking requests matching particular criteria (such as requests from particular senders, requests containing certain keywords, requests received at certain dates or times, and so forth).

As one alternative to using configuration data, the user at the receiving e-mail client may be queried at Block 230 to determine whether he or she approves the processing of this history tracking request. An embodiment of the present invention may optionally be adapted for presenting the incoming request message that contains the history tracking request X-header to the user, and may do so to assist the user in making a decision at Block 230 (or for other purposes).

If the test in Block 230 has a negative result, processing continues at Block 270, which has been discussed above.

If the test in Block 230 has a positive result, then processing reaches Block 240 where the requested tracking information is obtained. The processing performed at Block 240 preferably comprises collecting already-generated tracking information. Or, the tracking information may be generated responsive to reaching Block 240. In one approach, a user of an e-mail client configures the client to store gathered history tracking information for a particular period of time, after which the information may be purged (either automatically or upon confirmation by the user). The e-mail system itself preferably tracks history associated with individual e-mail messages in an on-going manner after receipt of such messages, such as whether a message was automatically handled by a filter, what time it was received and what actions were performed upon the message by the user after receipt (including, by way of example, whether it was explicitly deleted by the user) and at what time those actions were performed, and so forth.

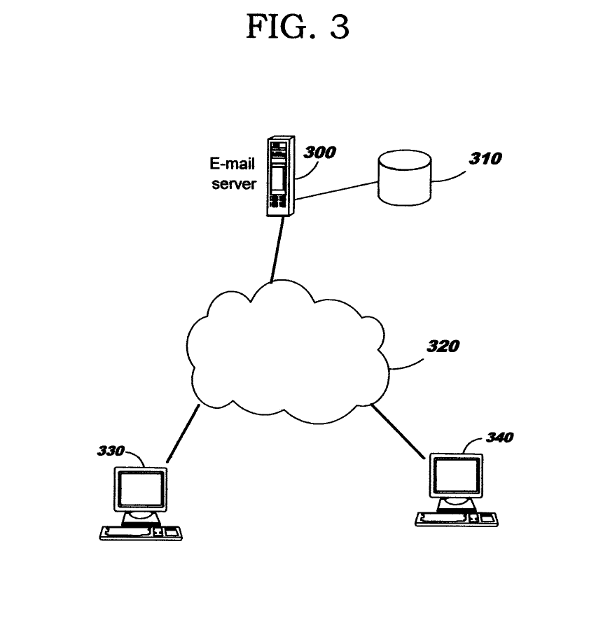

The history tracking information may be obtained from storage that is local to the e-mail client, or it may be obtained from another location such as a centralized database accessible to a plurality of e-mail clients. Or, portions of the history tracking information may be obtained from multiple locations. For example, a portion thereof may be obtained from the local e-mail client while another portion may be obtained from an e-mail server. Refer to FIG. 3, where components used in an embodiment of the present invention are illustrated. As shown therein, an e-mail server 300 is connected by way of communication links using, for example, a network 320 such as the public Internet to a plurality of e-mail clients 330, 340. E-mail client 330 may be, for example, the client used by the sender of the original e-mail message and the history tracking request described herein, and e-mail client 340 may be the client that receives those messages and sends the reply with the history tracking information. FIG. 3 illustrates a scenario where the history tracking information is stored in a database 310 that is operably connected (e.g., by way of communication links, using local storage, etc.) to e-mail server 300. Accordingly, the processing of Block 240 may comprise sending a request for history tracking information from e-mail client 340 through network 320 to e-mail server 300, responsive to which e-mail server 300 retrieves information from database 310 and returns that information through network 320 to e-mail client 340 (to be subsequently sent to e-mail client 330, for example, in a reply message).

Referring again to FIG. 2, in Block 250, the tracking data obtained at Block 240 is preferably appended to the body of a reply message that is associated with the original e-mail message (e.g., by copying information from the incoming e-mail message that contains the request X-header), where this reply message preferably uses a reply X-header that connotes a history tracking reply and that will trigger the history tracking reply processing at the original sending e-mail system (as discussed in more detail, below, with reference to Blocks 140-160 of FIG. 1).

It may happen, in some cases, that no history tracking information is available. In such cases, an embodiment of the present invention may supply a message to this effect in the reply message created at Block 250. Or, this scenario may be accommodated by transferring control from Block 240 to Block 270 (which has been discussed above). While logic pertaining to the “absence of history tracking information” scenario has not been explicitly shown in FIG. 1 or 2, it will be obvious to those of skill in the art how the depicted logic may be adapted to support this scenario.

At Block 260, the reply message is then sent to the original sending e-mail system (i.e., the e-mail client from which the request X-header was sent), after which the processing of FIG. 2 may exit. (As one alternative, not shown in FIG. 2, a message or other notification for the receiving user may be generated prior to exiting from FIG. 2 to indicate, for example, that the reply message with the X-header and the history tracking information has been sent).

Referring again to FIG. 1, Block 140 tests whether a reply X-header is received in response to the request X-header sent at Block 130. If this test has a negative result, then a delay or wait may be used (Block 150) after which the test may be repeated (as shown in FIG. 1 by returning control to Block 140). As will be obvious, an event-driven approach, “switch” statement processing, or other approach may be used to detect arrival of the message containing the reply X-header rather than using delays and iteratively testing, and the processing in FIG. 1 is therefore to be considered as illustrative but not limiting.

When the test in Block 140 has a positive result, then processing reaches Block 160 where the history tracking information from the incoming reply message is preferably presented to the user. As one alternative, the history tracking information might be stored in a repository, such as a log file or database, from which the user may retrieve the information at some subsequent time. Or, the history tracking information might be processed programmatically, for example by a report generator. Control may transfer from Block 160 to Block 120, thereby exiting from the processing in FIG. 2. (The manner in which the history tracking information is used at the original e-mail client user does not form part of the present invention, and Block 160 should therefore be considered as illustrative but not limiting).

While the e-mail history tracking of the present invention is described herein with reference to use of X-headers, this is by way of illustration but not of limitation, and other techniques may be used without deviating from the scope of the present invention. As one example, an embodiment of the present invention may use an e-mail object that is embedded in e-mail messages, where the e-mail object in a request message specifies a request for tracking e-mail history when sent (instead of a request X-header) at Block 130 of FIG. 1 and where the e-mail object in a reply message provides the requested history tracking information when sent (instead of a reply X-header) at Block 250 of FIG. 2.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

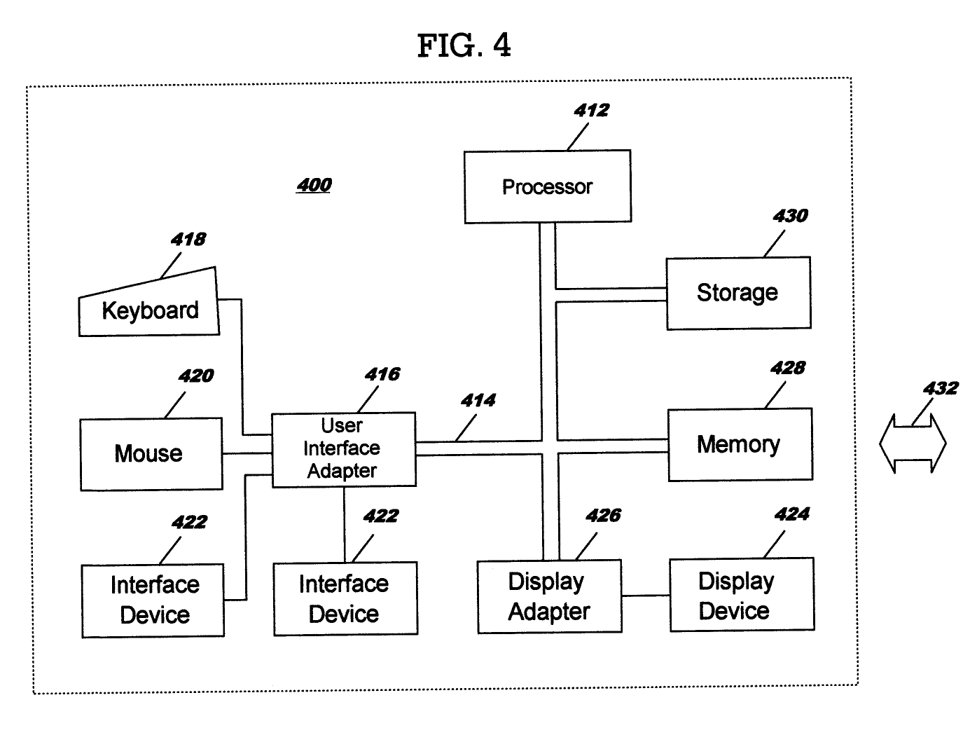

Referring now to FIG. 4, a data processing system 400 suitable for storing and/or executing program code includes at least one processor 412 coupled directly or indirectly to memory elements through a system bus 414. The memory elements can include local memory 428 employed during actual execution of the program code, bulk storage 430, and cache memories (not shown) which provide temporary storage of at least some program code in order to reduce the number of times code must be retrieved from bulk storage during execution.

Input/output (“I/O”) devices (including but not limited to keyboards 418, displays 424, pointing devices 420, other interface devices 422, etc.) can be coupled to the system either directly or through intervening I/O controllers or adapters (416, 426).

Network adapters may also be coupled to the system to enable the data processing system to become coupled to other data processing systems or remote printers or storage devices through intervening private or public networks (as shown generally at 432). Modems, cable modem attachments, wireless adapters, and Ethernet cards are just a few of the currently-available types of network adapters.

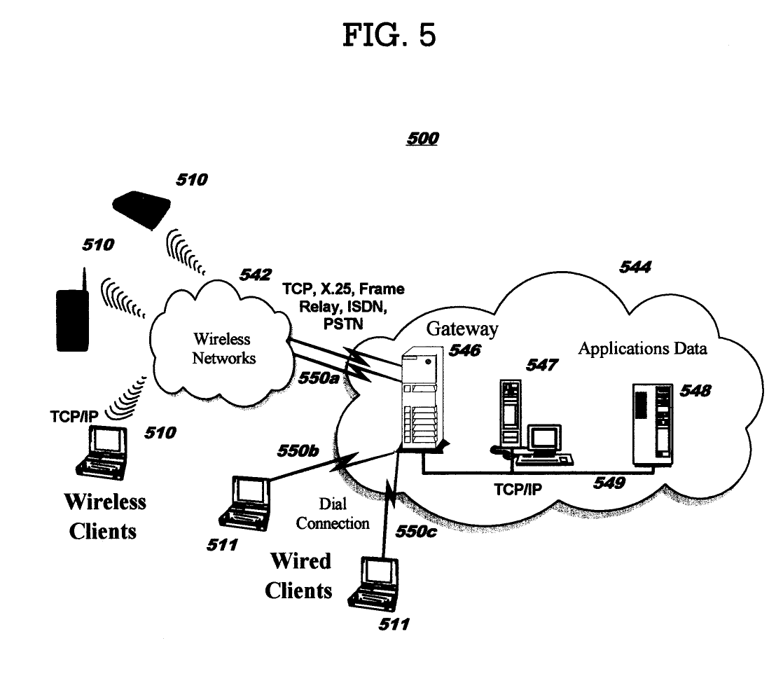

FIG. 5 illustrates a data processing network environment 500 in which the present invention may be practiced. The data processing network 500 may include a plurality of individual networks, such as wireless network 542 and network 544. A plurality of wireless devices 510 may communicate over wireless network 542, and a plurality of wired devices, shown in the figure (by way of illustration) as workstations 511, may communicate over network 544. Additionally, as those skilled in the art will appreciate, one or more local area networks (“LANs”) may be included (not shown), where a LAN may comprise a plurality of devices coupled to a host processor.

Still referring to FIG. 5, the networks 542 and 544 may also include mainframe computers or servers, such as a gateway computer 546 or application server 547 (which may access a data repository 548). A gateway computer 546 serves as a point of entry into each network, such as network 544. The gateway 546 may be preferably coupled to another network 542 by means of a communications link 550a. The gateway 546 may also be directly coupled to one or more workstations 511 using a communications link 550b, 550c, and/or may be indirectly coupled to such devices. The gateway computer 546 may be implemented utilizing an Enterprise Systems Architecture/390® computer available from IBM. Depending on the application, a midrange computer, such as an Application System/400® (also known as an AS/400® may be employed. (“Enterprise Systems Architecture/390”, “Application System/400”, and “AS/400” are registered trademarks of IBM in the United States, other countries, or both).

The gateway computer 546 may also be coupled 549 to a storage device (such as data repository 548).

Those skilled in the art will appreciate that the gateway computer 546 may be located a great geographic distance from the network 542, and similarly, the wireless devices 510 and/or workstations 511 may be located some distance from the networks 542 and 544, respectively. For example, the network 542 may be located in California, while the gateway 546 may be located in Texas, and one or more of the workstations 511 may be located in Florida. The wireless devices 510 may connect to the wireless network 542 using a networking protocol such as the Transmission Control Protocol/Internet Protocol (“TCP/IP”) over a number of alternative connection media, such as cellular phone, radio frequency networks, satellite networks, etc. The wireless network 542 preferably connects to the gateway 546 using a network connection 550a such as TCP or User Datagram Protocol (“UDP”) over IP, X.25, Frame Relay, Integrated Services Digital Network (“ISDN”), Public Switched Telephone Network (“PSTN”), etc. The workstations 511 may connect directly to the gateway 546 using dial connections 550b or 550c. Further, the wireless network 542 and network 544 may connect to one or more other networks (not shown), in an analogous manner to that depicted in FIG. 5.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of tracking history of an electronic mail (“e-mail”) message, comprising:
sending, from a first e-mail client to a second e-mail client, a tracking request to request history pertaining to an e-mail message previously sent from the first e-mail client to the second e-mail client, the tracking request identifying the previously-sent e-mail message and configured to cause the second e-mail client to return the requested history to the first e-mail client.

2. The method according to claim 1, wherein the tracking request comprises a copy of the previously-sent e-mail message with a tracking request X-header appended thereto.

3. The method according to claim 1, wherein the tracking request comprises a copy of the previously-sent e-mail message with a tracking request e-mail object embedded therein.

4. The method according to claim 1, further comprising:
receiving the requested history, at the first e-mail client from the second e-mail client, in a reply message returned from the second e-mail client responsive to receiving the tracking request from the first e-mail client.

5. A computer-implemented method of tracking history of an electronic mail (“e-mail”) message, comprising:
receiving, at a second e-mail client from a first e-mail client, a tracking request that requests history pertaining to an e-mail message previously sent from the first e-mail client to the second e-mail client, the tracking history tracking request identifying the previously-sent e-mail message;
gathering the requested history, by the second e-mail client; and
returning the requested history as a reply sent from the second e-mail client to the first e-mail client.

6. The method according to claim 5, wherein the reply is configured to cause the first e-mail client to process the returned history.

7. The method according to claim 5, wherein the reply comprises a reply e-mail message associated with the previously-sent e-mail message, the reply e-mail message specifying the requested history and comprising an appended tracking reply X-header.

8. The method according to claim 5, wherein the reply comprises a copy of the previously-sent e-mail message with a tracking reply X-header appended thereto.

9. The method according to claim 5, wherein the reply comprises a copy of the previously-sent e-mail message with a tracking reply e-mail object embedded therein.

10. The method according to claim 5, wherein the gathering further comprises obtaining the requested history from local storage accessible to the second e-mail client.

11. The method according to claim 5, wherein the gathering further comprises obtaining the requested history from storage accessible to an e-mail server upon request from the second e-mail client.

12. The method according to claim 5, further comprising:
determining, at the second e-mail client, whether a user of the second e-mail client approves providing the requested history; and
suppressing the gathering and the returning if so.

13. The method according to claim 12, wherein the determining further comprises querying the user.

14. The method according to claim 12, wherein the determining further comprises programmatically evaluating configuration data accessible to the second e-mail client.

15. The method according to claim 5, wherein the requested history pertains to how the previously-sent e-mail message was processed at the first e-mail client.

16. The method according to claim 5, wherein the requested history pertains to whether the previously-sent e-mail message was deleted subsequent to receipt at the first e-mail client.

17. The method according to claim 1, wherein the requested history pertains to whether the previously-sent e-mail message was filtered by an automated filter subsequent to receipt at the first e-mail client.

18. An electronic mail (“e-mail”) history tracking system in a computing environment connected to a network, comprising:
a history tracking request module for forwarding, from a first e-mail client to a second e-mail client, a tracking request to request history pertaining to an e-mail message previously sent from the first e-mail client to the second e-mail client, the tracking request identifying the previously-sent e-mail message and configured to cause the second e-mail client to return the requested history to the first e-mail client; and
a history reply module for forwarding, from the second e-mail client to the first e-mail client, a reply message responsive to the tracking request from the first e-mail client, the reply message specifying the requested history and configured to cause the first e-mail client to process the specified history.

19. A computer program product for tracking history pertaining to an electronic mail (“e-mail”) message, wherein the computer program product is embodied on one or more computer-readable media and comprises computer-readable instructions for:
forwarding a tracking request from a first e-mail client to a second e-mail client, the tracking request to request history pertaining to an e-mail message previously sent from the first e-mail client to the second e-mail client, the tracking request identifying the previously-sent e-mail message and configured to cause the second e-mail client to return the requested history to the first e-mail client; and
forwarding a reply from the second e-mail client to the first e-mail client, responsive to the second e-mail client receiving the tracking request from the first e-mail client and returning the gathered history in the reply, the reply configured to cause the first e-mail client to process the gathered history.
